(19) United States
(12) Patent Application Publication
(10) Pub. No.: US 2023/0394289 A1
(43) Pub. Date: Dec. 7, 2023

(54) COMPUTER-READABLE RECORDING MEDIUM STORING LEARNING MODEL QUANTIZATION PROGRAM AND LEARNING MODEL QUANTIZATION METHOD

(71) Applicant: Fujitsu Limited, Kawasaki-shi, Kanagawa (JP)

(72) Inventor: Satoki TSUJI, Kawasaki (JP)

(73) Assignee: Fujitsu Limited, Kawasaki-shi, Kanagawa (JP)

(21) Appl. No.: 18/163,902

(22) Filed: Feb. 3, 2023

(30) Foreign Application Priority Data
Jun. 6, 2022 (JP) 2022-091585

(51) Int. Cl. G06N 3/0495; G06N 3/08

(52) U.S. Cl. CPC G06N 3/0495; G06N 3/08

(57) ABSTRACT

A non-transitory computer-readable recording medium stores a learning model quantization program for causing a computer to execute a process including: in an objective function for searching for a combination of layers in which parameters of a machine-learned model using a neural network are quantized, the objective function including inference accuracy of the quantized model and an index related to a compression ratio of the model, setting a specific gravity such that the specific gravity of the index related to the compression ratio with respect to the inference accuracy decreases as the compression ratio increases; selecting a layer in which the objective function is optimized, as a layer in which the parameters are quantized; and outputting a relationship between the inference accuracy for the model obtained by quantizing the parameters of the selected layer and the index related to the compression ratio.

### CROSS-REFERENCE TO RELATED APPLICATION

This application is based upon and claims the benefit of priority of the prior Japanese Patent application No. 2022-91585, filed on Jun. 6, 2022, the entire contents of which are incorporated herein by reference.

### FIELD

The embodiment discussed herein is related to a computer-readable recording medium storing a learning model quantization program and a learning model quantization method.

### BACKGROUND

Learning and inference of a machine learning model using a neural network have a problem in that calculation cost is high. Accordingly, there is a technique for suppressing the above-described calculation cost by executing learning and inference by applying a technique called quantization that reduces operation accuracy of parameters in a neural network. When parameters are quantized, there is a trade-off in which, as the number of parameters to which quantization is applied increases, the compression ratio of the model increases, leading to a reduction in calculation cost but, at the same time, a decrease in inference accuracy becomes significant. Accordingly, a method capable of maintaining high inference accuracy while quantizing a larger number of parameters is desired.

U.S. Patent application Publication No. 2019/0370658, Japanese National Publication of International Patent application No. 2022-501676, International Publication Pamphlet No. 2019/008752, Japanese Laid-open Patent Publication No. 2020-113273, and Japanese Laid-open Patent Publication No. 2021-168042 are disclosed as related art.

### SUMMARY

According to an aspect of the embodiments, a non-transitory computer-readable recording medium stores a learning model quantization program for causing a computer to execute a process including: in an objective function for searching for a combination of layers in which parameters of a machine-learned model using a neural network are quantized, the objective function including inference accuracy of the quantized model and an index related to a compression ratio of the model, setting a specific gravity such that the specific gravity of the index related to the compression ratio with respect to the inference accuracy decreases as the compression ratio increases; selecting a layer in which the objective function is optimized, as a layer in which the parameters are quantized; and outputting a relationship between the inference accuracy for the model obtained by quantizing the parameters of the selected layer and the index related to the compression ratio.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining a problem in a case where a hyper parameter is fixed;

FIG. 2 is a diagram for explaining a case where the hyper parameter is dynamically changed;

FIG. 3 is a functional block diagram of a learning model quantization apparatus;

FIG. 4 is a diagram for explaining a feature of a quantization result;

FIG. 5 is a diagram illustrating an example of a function for setting β;

FIG. 6 is a block diagram illustrating a schematic configuration of a computer that functions as the learning model quantization apparatus;

FIG. 7 is a flowchart illustrating an example of a learning model quantization process;

FIG. 8 is a flowchart illustrating an example of a quantization layer search process; and

FIG. 9 is a diagram for explaining evaluation of the effectiveness of the present embodiment.

### DESCRIPTION OF EMBODIMENTS

For example, a method of forming a compression model by using a pre-trained deep neural network model as a candidate model has been proposed. According to this method, the sparsity of a candidate model is increased, at least one batch normalization layer existing in the candidate model is deleted, and all the remaining weights are quantized into a fixed-point representation to form a compression model. According to this method, the accuracy of the compression model is determined by using a training and verification data set for an end user. According to this method, when the accuracy is improved, the compression of the candidate model is repeated. When the accuracy decreases, a hyper parameter for compressing the candidate model is adjusted, and the compression of the candidate model is repeated.

For example, there has been proposed a neural network quantization apparatus that determines a plurality of pieces of data waiting for quantization from target data of a neural network, and obtains a quantization result of the target data based on quantized data corresponding to each piece of data waiting for quantization. In this apparatus, the quantized data of each piece of data waiting for quantization is obtained by quantization using the corresponding quantization parameter.

For example, a data processing apparatus that processes input data by using a neural network has been proposed. This apparatus generates quantization information in which quantization steps are defined, and encodes network configuration information including parameter data quantized in the quantization steps and the quantization information to generate compressed data.

For example, a method has been proposed in which learning of a neural network is repeatedly performed, a weight statistical quantity of each of layers included in the neural network is analyzed, and a layer to be quantized with low bit accuracy is determined based on the analyzed statistical quantity. According to this method, a quantized neural network is generated by quantizing the determined layer with low bit accuracy.

For example, an information processing apparatus has been proposed that efficiently compresses a learned model so as to contribute to an increase in the speed of operation. This apparatus performs an operation on inference data using a learned model, and extracts input data and output data when a matrix operation is performed in a specific layer to be compressed in the operation. This apparatus performs an operation on the extracted input data with a compression weight matrix in which patterns of zero and non-zero, in which an element at a specific subscript of the matrix is zero, are applied to a matrix of a specific layer. This apparatus performs an operation for reducing an error between output data of an operation result and the extracted output data, and obtains a compression weight matrix in which weights are optimized. This apparatus relearns the learned model in which the compression weight matrix is applied to a specific layer by using correct answer data while keeping zero at the position of zero.

Although a method using learning for compression of a neural network model has been proposed in the related art, there is a problem in that calculation cost for model compression is high in this case.

The neural network is constituted by a large number of layers. A change in inference accuracy due to quantization differs for each layer. For this reason, for example, the greedy algorithm is used to quantize layers one by one in order from a layer with a small decrease in inference accuracy, and a combination of quantization layers that increases the inference accuracy and the compression ratio of the quantized model is searched for.

However, in the related art to which the greedy algorithm is applied, a hyper parameter that is introduced to an objective function and represents a specific gravity between the inference accuracy and the compression ratio of the model is fixed during the search. For this reason, there is a problem in that a model that maintains high inference accuracy by quantizing more parameters may not be searched for in some cases.

According to one aspect, an object of the disclosed technique is to improve a compression ratio of a model while maintaining inference accuracy in quantization of parameters of the machine-learned model using a neural network.

Hereinafter, an example of an embodiment according to the disclosed technique will be described with reference to the drawings.

Before describing the details of the embodiment, in a case where a layer to be quantized is searched for from layers of a neural network by using the greedy algorithm, a problem in a case where a hyper parameter β introduced to an objective function is fixed during the search will be described. The hyper parameter β is a parameter representing a specific gravity in the objective function between inference accuracy of a model after quantization and an index related to a compression ratio of the model (hereafter referred to as “compression index”).

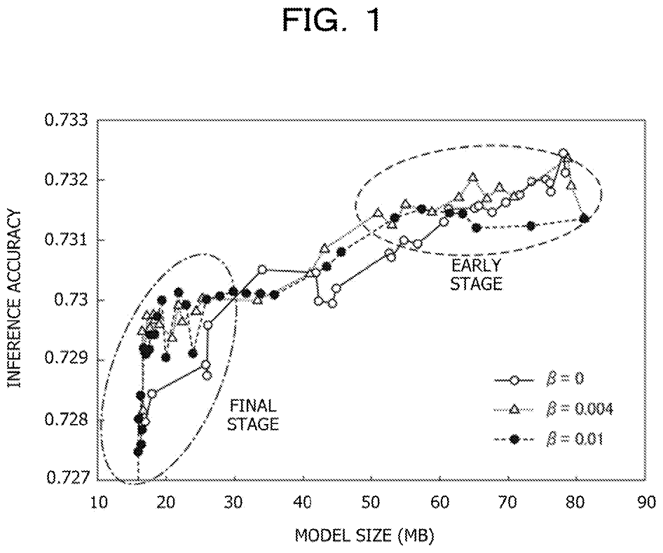

In the greedy algorithm, a step of selecting one layer in which the objective function is optimized and quantizing parameters of the layer is repeated. As illustrated in FIG. 1, for each quantization of one layer, the inference accuracy for the compression index after quantization is plotted. According to the example illustrated in FIG. 1, a model size after quantization is used as the compression index. A quantization model meeting the requirements is selected from the combinations of the quantized layers indicated by the plot points. The example illustrated in FIG. 1 represents the inference accuracy with respect to the model size in a case where the objective function described below is applied and 0, 0.004, and 0.01 are each set as a value of β.

Objective function=Inference accuracy×{log(Model compression ratio)}^{β}

As closer to the upper left in the graph illustrated in FIG. 1, it is indicated that the compression ratio of the model is higher and the inference accuracy is higher, for example, the quantization efficiency is higher. According to the greedy algorithm, the model size decreases as the step proceeds. For example, as indicated by a broken line portion in FIG. 1, a stage in which the model size is large is an early stage of the quantization, and as indicated by a one dot chain line portion, a stage in which the model size is small is a final stage of the quantization. As illustrated in FIG. 1, the search results of the related-art method indicate that a decrease in the inference accuracy is small at the early stage of the quantization and is large at the final stage of the quantization.

For example, in order to further improve the quantization efficiency, it is effective to preferentially quantize a layer having a large number of parameters at the early stage of the quantization and preferentially quantize a layer capable of maintaining the highest inference accuracy at the final stage of the quantization. However, when the hyper parameter β of the objective function is a fixed value, such quantization may not be implemented.

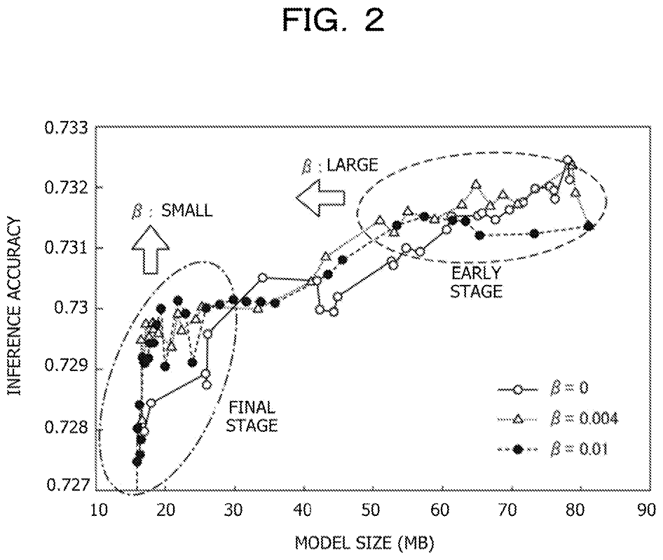

Accordingly, in the present embodiment, as illustrated in FIG. 2, the quantization efficiency is improved by dynamically changing the hyper parameter β. For example, in the case of the above-described objective function, a layer in which the compression ratio of the model after quantization is high is preferentially selected by increasing β at the early stage of the quantization, and a layer in which the inference accuracy of the model after quantization is high is preferentially selected by decreasing β at the final stage of the quantization.

Hereinafter, details of a learning model quantization apparatus according to the present embodiment will be described. In the present embodiment, a case where a layer to be quantized is searched by a greedy algorithm using the same objective function as described above will be described. In the greedy algorithm, a process of searching for a predetermined number (one in the present embodiment) of layers to be quantized is set as one step, and the search in the next step is executed on the model P obtained by quantizing the parameter of the selected layer as a result of the search in the previous step.

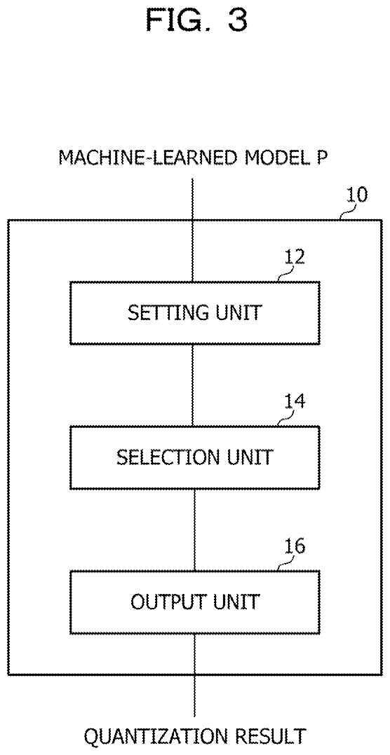

As illustrated in FIG. 3, a machine-learned model P using a neural network is input to a learning model quantization apparatus 10. The learning model quantization apparatus 10 quantizes the model P and outputs a quantization result (details will be described later). As illustrated in FIG. 3, the learning model quantization apparatus 10 functionally includes a setting unit 12, a selection unit 14, and an output unit 16.

The setting unit 12 sets the hyper parameter β of an objective function for searching for a combination of layers in which the parameters of the model P are quantized. As described above, in the present embodiment, the same objective function as described above is used as the objective function. For example, the objective function includes the inference accuracy of the quantized model P and the compression index of the model P. For example, the compression index may be a model size after quantization, the number of quantized parameters, a ratio of the quantized parameters to all parameters included in the model P, or the like. In the greedy algorithm, the number of steps of the process for searching for a layer to be quantized may be used as the compression index. The objective function includes the hyper parameter β representing the specific gravity between the inference accuracy and the compression index in the objective function.

For example, the setting unit 12 sets the hyper parameter β such that the specific gravity of the compression index with respect to the inference accuracy decreases as the compression ratio of the model P by quantization increases. For example, in the case of the above-described objective function, the setting unit 12 sets the hyper parameter β such that the hyper parameter β in each step decreases stepwise as the step of the sequential quantization by the greedy algorithm proceeds.

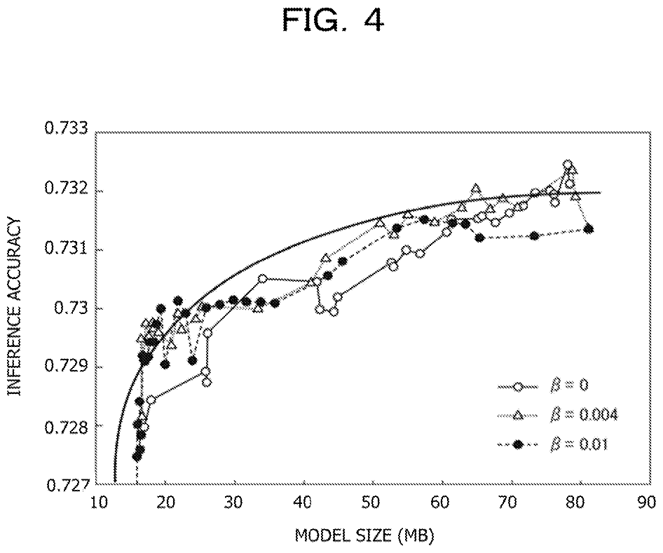

As illustrated in FIG. 4, the inference accuracy with respect to the compression index (model size in the example of FIG. 4) after the quantization in each step of the quantization is not linear and transitions so as to draw a trajectory close to an upward convex shape. For this reason, the value of the hyper parameter β is sufficiently reduced by the final stage in which a decrease in inference accuracy is significant. Accordingly, the setting unit 12 may set the value of β such that the value of β in each step at the final stage from a predetermined step to the end step of the quantization is less than or equal to a predetermined ratio with respect to the value of β in each step at the early stage from the start step to the predetermined step of the quantization.

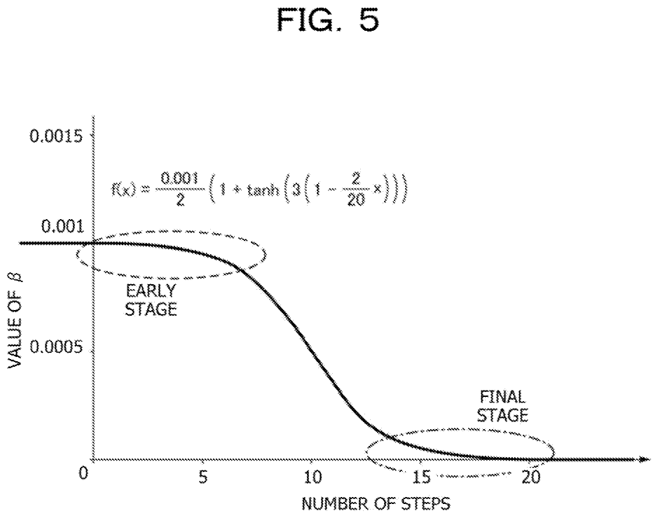

The setting unit 12 may change the setting of β as described above in accordance with a predetermined function in which the compression index is a variable. As this function, a function such as a form obtained by inverting a step function or a sigmoid function with respect to the Y axis is suitable. FIG. 5 illustrates a case where a hyperbolic tangent function tanh is used as a function for setting β. In this case, the setting unit 12 sets β based on β=f(x) using f(x) represented by Expression (1) below.

$$f ( x ) = \frac{{β}_{0}}{2} [ 1 + tanh \{ w ( 1 - \frac{2}{N} x ) \} ] \qquad ( 1 )$$

In Expression (1), β represents an initial value of β, w represents a value for determining the slope of tanh, N represents the total number of layers of the model P, and x (=1 to N) represents the number of steps (x-th step) for searching for a layer to be quantized. The example illustrated in FIG. 5 is a case where β₀=0.001, w=3, and N=20. As illustrated in FIG. 5, by setting β using the function of Expression (1), a layer to be quantized is selected such that the priority of the compression ratio of the model P is high at the early stage where the inference accuracy is unlikely to decrease. By setting β≈0 at the final stage, a layer in which only the inference accuracy is substantially maximized is selected.

The selection unit 14 searches for a layer in which parameters are quantized based on the objective function, and selects a layer in which the objective function is optimized. For example, the selection unit 14 obtains the inference accuracy and the compression index in a case where each layer of the model P is quantized, and calculates the value of the objective function by using the obtained inference accuracy, compression index, and β set according to the step. The selection unit 14 selects a layer in which the value of the calculated objective function is maximized. The selection unit 14 sets a model obtained by quantizing the selected layer as a new model P, and transfers the quantized model P and the inference accuracy and the compression index for the model P to the output unit 16.

The output unit 16 stores the inference accuracy and the compression index for the quantized model P that are transferred from the selection unit 14. After the final step ends, the output unit 16 generates and outputs a quantization result indicating the relationship between the inference accuracy and the compression index. For example, the output unit 16 may generate a graph in which the inference accuracy with respect to the model size is plotted as illustrated in FIG. 1 and the like, as the quantization result.

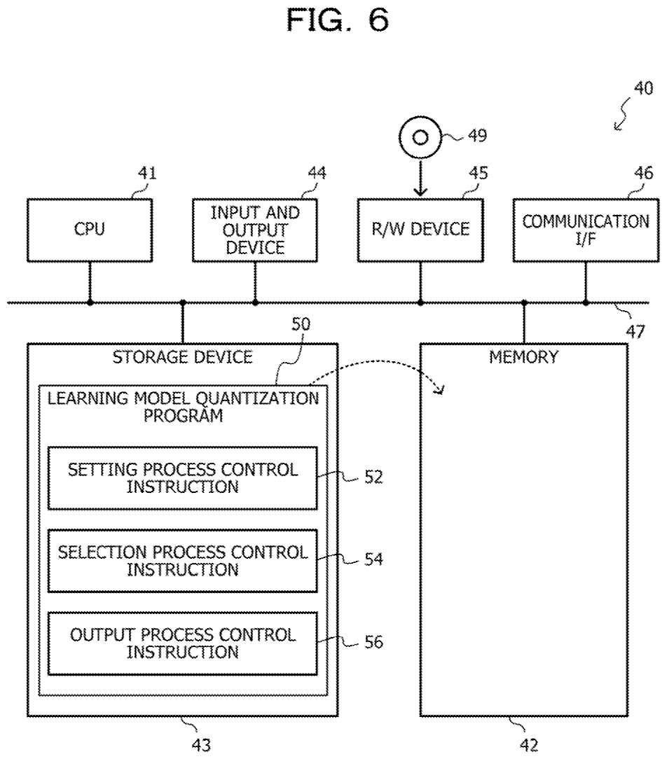

For example, the learning model quantization apparatus 10 may be implemented with a computer 40 illustrated in FIG. 6. The computer 40 includes a central processing unit (CPU) 41, a memory 42 serving as a temporary storage area, and a nonvolatile storage device 43. The computer 40 includes an input and output device 44 such as an input device and a display device, and a read/write (R/W) device 45 that controls reading and writing of data from and to a storage medium 49. The computer 40 includes a communication interface (I/F) 46 that is coupled to a network such as the Internet. The CPU 41, the memory 42, the storage device 43, the input and output device 44, the R/W device 45, and the communication I/F 46 are coupled to each other via a bus 47.

For example, the storage device 43 is a hard disk drive (HDD), a solid-state drive (SSD), a flash memory, or the like. A learning model quantization program 50 for causing the computer 40 to function as the learning model quantization apparatus 10 is stored in the storage device 43 serving as a storage medium. The learning model quantization program 50 includes a setting process control instruction 52, a selection process control instruction 54, and an output process control instruction 56.

The CPU 41 reads the learning model quantization program 50 from the storage device 43, develops the learning model quantization program 50 in the memory 42, and sequentially executes the control instructions included in the learning model quantization program 50. By executing the setting process control instruction 52, the CPU 41 operates as the setting unit 12 illustrated in FIG. 3. By executing the selection process control instruction 54, the CPU 41 operates as the selection unit 14 illustrated in FIG. 3. By executing the output process control instruction 56, the CPU 41 operates as the output unit 16 illustrated in FIG. 3. Accordingly, the computer 40, which executes the learning model quantization program 50, functions as the learning model quantization apparatus 10. The CPU 41, which executes the program, is hardware.

The functions implemented by the learning model quantization program 50 may be implemented by, for example, a semiconductor integrated circuit, for example, an application-specific integrated circuit (ASIC), a field-programmable gate array (FPGA), or the like.

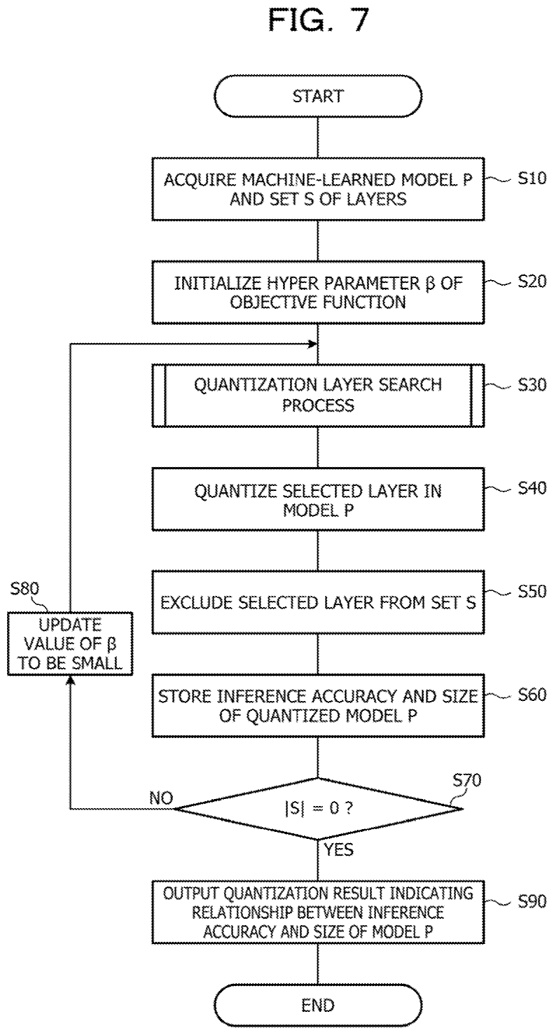

Next, an operation of the learning model quantization apparatus 10 according to the present embodiment will be described. After the machine-learned model P is input to the learning model quantization apparatus 10 and an instruction to output a quantization result is given, the learning model quantization apparatus 10 executes a learning model quantization process illustrated in FIG. 7. The learning model quantization process is an example of a learning model quantization method of the disclosed technique.

In step S10, the setting unit 12 acquires the machine-learned model P and a set S of layers constituting the model P. Next, in step S20, the setting unit 12 initializes the hyper parameter β of the objective function. For example, the setting unit 12 sets β to an initial value β₀. Next, in step S30, the selection unit 14 executes a quantization layer search process.

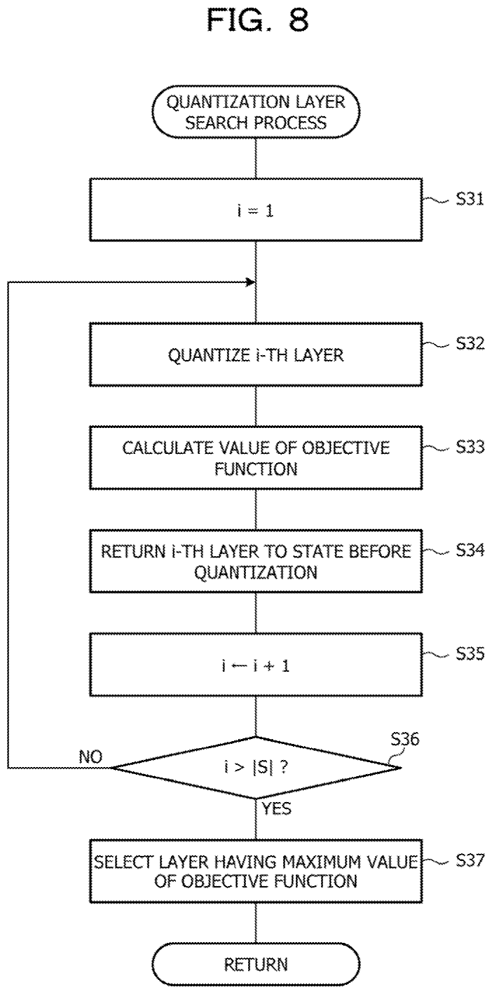

The quantization layer search process will be described with reference to FIG. 8.

In step S31, the selection unit 14 sets variable i to 1. Next, in step S32, the selection unit 14 quantizes an i-th layer in order from an input layer of the model P. A known method may be applied as a quantization method, and thus detailed description thereof will be omitted.

Next, in step S33, the selection unit 14 obtains the inference accuracy and the compression index of the quantized model P of the i-th layer. For example, the inference accuracy may be a correct answer rate or the like based on an output when data with a correct answer is input to the quantized model P and the correct answer of the output. As described above, the compression index may be the model size after the quantization, the number of quantized parameters, the ratio of the quantized parameters to all parameters included in the model P, the number of steps of the quantization layer search process, or the like. By using the obtained inference accuracy and compression index and the value of β set by the setting unit 12, the selection unit 14 calculates the value of the objective function.

Next, in step S34, the selection unit 14 returns the i-th layer to the state before the quantization. Next, in step S35, the selection unit 14 increments the variable i by 1. Next, in step S36, the selection unit 14 determines whether or not the variable i exceeds the size |S| (the number of layers included in the set S) of the set S of layers. If i>|S|, the process proceeds to step S37. If i≤|S|, the process returns to step S32.

In step S37, the selection unit 14 selects a layer in which the value of the objective function calculated in step S33 described above is maximized, and the process returns to the learning model quantization process (FIG. 7).

Next, in step S40, the selection unit 14 quantizes the layer selected in the quantization layer search process in the model P, and sets the quantized model as a new model P. Next, in step S50, the selection unit 14 excludes the selected layer from the set S of layers. Next, in step S60, the selection unit 14 transfers the inference accuracy and the compression index for the quantized model P to the output unit 16. The output unit 16 temporarily stores the received inference accuracy and compression index in a predetermined storage area.

Next, in step S70, the setting unit 12 determines whether or not the size |S| of the set S of layers is 0. If |S|=0, the process proceeds to step S90. If |S|≠0, the process proceeds to step S80.

In step S80, the setting unit 12 updates the value of β such that the value of β decreases in accordance with, for example, Expression (1), sets the updated value of β in the objective function, and the process returns to step S30. In step S90, the output unit 16 generates and outputs a quantization result indicating the relationship between the inference accuracy and the compression index by using the inference accuracy and the compression index of each step stored in step S60 described above, and the learning model quantization process ends.

As described above, the learning model quantization apparatus according to the present embodiment searches for, by using the objective function, a combination of layers in which the parameters of the machine-learned model using the neural network are quantized. The objective function includes the inference accuracy of the quantized model and the compression index of the model. At this time, the learning model quantization apparatus dynamically sets the hyper parameter β of the objective function such that the specific gravity of the compression index with respect to the inference accuracy in the objective function decreases as the compression ratio of the model increases. The learning model quantization apparatus selects a layer in which the objective function is optimized as a layer in which parameters are quantized, and outputs the relationship between the inference accuracy and the compression index for a model obtained by quantizing the parameters of the selected layer. Accordingly, in the quantization of the parameters of the machine-learned model using the neural network, the model compression ratio may be improved while maintaining the inference accuracy.

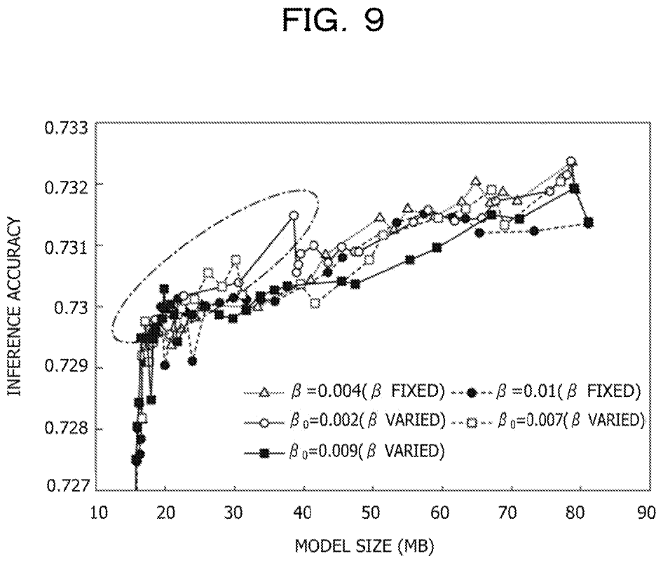

An evaluation of the effectiveness of the present embodiment will be described. FIG. 9 is a graph illustrating a quantization result of a model used for a task of classifying images of 1000 categories of ImageNet. In this evaluation, ResNet-34 has been used as the model, and 6-bit quantization has been applied to quantization of parameters. As illustrated in FIG. 9, “β fixed” is a quantization result obtained by a method (hereafter, referred to as a “comparison method”) in which a layer to be quantized is searched for by the greedy algorithm and the hyper parameter β of the objective function is fixed. “β varied” is a quantization result obtained by the method of the present embodiment. As for the comparison method, a plurality of fixed values of β are tried, and the quantization results in a case where β=0.004 and β=0.01, in which the quantization efficiency is the best, are illustrated. As for the present embodiment, a plurality of values of β₀ that is the initial value of β are tried, and the quantization results in a case where β₀=0.002, β₀=0.007, and β₀=0.009, in which the quantization efficiency is the best, are illustrated.

As illustrated in FIG. 9, at the final stage of the search in which a decrease in the inference accuracy is significant (one dot chain line portion), it is possible to find a combination of quantization layers that maintains higher inference accuracy by the method according to the present embodiment than by the comparison method, and it is understood that the quantization efficiency is successfully improved. As compared with the comparison method, the method according to the present embodiment achieves an improvement of +0.14% at the maximum in the inference accuracy when the model sizes after the quantization are the same.

In the above-described embodiment, the description has been made of the case where the hyper parameter β is the objective function related to the compression index and the objective function that has a larger value as the inference accuracy is higher and the compression ratio is higher is used. For this reason, although the case where β decreases as the search step proceeds has been described, the embodiment is not limited thereto. When β is related to the inference accuracy, β may be gradually increased. In a case where the value of the objective function decreases as the inference accuracy increases and the compression ratio increases, a layer in which the objective function is minimized may be selected.

Although the function representing the value of β with respect to the number of steps has been described as an example of the function for setting β in the above-described embodiment, the function is not limited to this and may be a function representing the value of β with respect to the model size after the quantization or the number of quantized parameters. In this case, the disclosed technique may also be applied to an algorithm in which the model size does not simply decrease as the number of steps increases.

Although the learning model quantization program is stored (installed) in the storage device in advance in the above-described embodiment, the embodiment is not limited thereto. The program according to the disclosed technology may be provided in a form of being stored in a storage medium such as a compact disc read-only memory (CD-ROM), a Digital Versatile Disc (DVD)-ROM, a Universal Serial Bus (USB) memory, or the like.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a learning model quantization program for causing a computer to execute a process comprising:
in an objective function for searching for a combination of layers in which parameters of a machine-learned model using a neural network are quantized, the objective function including inference accuracy of the quantized model and an index related to a compression ratio of the model, setting a specific gravity such that the specific gravity of the index related to the compression ratio with respect to the inference accuracy decreases as the compression ratio increases;
selecting a layer in which the objective function is optimized, as a layer in which the parameters are quantized; and
outputting a relationship between the inference accuracy for the model obtained by quantizing the parameters of the selected layer and the index related to the compression ratio.

2. The non-transitory computer-readable recording medium according to claim 1, wherein
in the selecting a layer, a process of selecting a predetermined number of the layers at a time is set as one step, and a next step is executed on the model obtained by quantizing the parameters of the layer selected in a previous step, and
in the setting a specific gravity, the specific gravity is set such that the specific gravity in each step decreases stepwise as the step proceeds.

3. The non-transitory computer-readable recording medium according to claim 2, wherein
in the setting a specific gravity, the specific gravity is set such that the specific gravity in each step at a final stage from a predetermined step to an end step with respect to each step at an early stage from a start step to the predetermined step is less than or equal to a predetermined ratio.

4. The non-transitory computer-readable recording medium according to claim 2, wherein
in the setting a specific gravity, a hyper parameter that corresponds to the specific gravity is changed in accordance with a predetermined function in which the index related to the compression ratio is a variable.

5. The non-transitory computer-readable recording medium according to claim 4, wherein
the function is a function based on a sigmoid function, a step function, or a hyperbolic tangent function.

6. The non-transitory computer-readable recording medium according to claim 2, wherein
the predetermined number is 1.

7. The non-transitory computer-readable recording medium according to claim 1, wherein
the index related to the compression ratio is a size of the model after the quantization, the number of the quantized parameters, or a ratio of the number of the quantized parameters to the number of all the parameters included in the model before the quantization.

8. A learning model quantization method comprising:
in an objective function for searching for a combination of layers in which parameters of a machine-learned model using a neural network are quantized, the objective function including inference accuracy of the quantized model and an index related to a compression ratio of the model, setting a specific gravity such that the specific gravity of the index related to the compression ratio with respect to the inference accuracy decreases as the compression ratio increases;
selecting a layer in which the objective function is optimized, as a layer in which the parameters are quantized; and
outputting a relationship between the inference accuracy for the model obtained by quantizing the parameters of the selected layer and the index related to the compression ratio.

9. The learning model quantization method according to claim 8, wherein
in the selecting a layer, a process of selecting a predetermined number of the layers at a time is set as one step, and a next step is executed on the model obtained by quantizing the parameters of the layer selected in a previous step, and
in the setting a specific gravity, the specific gravity is set such that the specific gravity in each step decreases stepwise as the step proceeds.

10. The learning model quantization method according to claim 9, wherein
in the setting a specific gravity, the specific gravity is set such that the specific gravity in each step at a final stage from a predetermined step to an end step with respect to each step at an early stage from a start step to the predetermined step is less than or equal to a predetermined ratio. wherein

11. The learning model quantization method according to claim 9, wherein
in the setting a specific gravity, a hyper parameter that corresponds to the specific gravity is changed in accordance with a predetermined function in which the index related to the compression ratio is a variable.

12. The learning model quantization method according to claim 11, wherein
the function is a function based on a sigmoid function, a step function, or a hyperbolic tangent function.

13. The learning model quantization method according to claim 9, wherein
the predetermined number is 1.

14. The learning model quantization method according to claim 8, wherein
the index related to the compression ratio is a size of the model after the quantization, the number of the quantized parameters, or a ratio of the number of the quantized parameters to the number of all the parameters included in the model before the quantization.

15. A learning model quantization device comprising:
a memory; and
a processor coupled to the memory and configured to:
in an objective function for searching for a combination of layers in which parameters of a machine-learned model using a neural network are quantized, the objective function including inference accuracy of the quantized model and an index related to a compression ratio of the model, set a specific gravity such that the specific gravity of the index related to the compression ratio with respect to the inference accuracy decreases as the compression ratio increases;
select a layer in which the objective function is optimized, as a layer in which the parameters are quantized; and
output a relationship between the inference accuracy for the model obtained by quantizing the parameters of the selected layer and the index related to the compression ratio.

16. The learning model quantization device according to claim 15, wherein
in a processing to select the layer, a process of selecting a predetermined number of the layers at a time is set as one step, and a next step is executed on the model obtained by quantizing the parameters of the layer selected in a previous step, and
in a processing to set the specific gravity, the specific gravity is set such that the specific gravity in each step decreases stepwise as the step proceeds.

17. The learning model quantization device according to claim 16, wherein
in the processing to set the specific gravity, the specific gravity is set such that the specific gravity in each step at a final stage from a predetermined step to an end step with respect to each step at an early stage from a start step to the predetermined step is less than or equal to a predetermined ratio.

18. The learning model quantization device according to claim 16, wherein
in the processing to set the specific gravity, a hyper parameter that corresponds to the specific gravity is changed in accordance with a predetermined function in which the index related to the compression ratio is a variable.

19. The learning model quantization device according to claim 18, wherein
the function is a function based on a sigmoid function, a step function, or a hyperbolic tangent function.

20. The learning model quantization device according to claim 15, wherein
the predetermined number is 1.
